(19) United States
(12) Patent Application Publication
(10) Pub. No.: US 2014/0315089 A1
(43) Pub. Date: Oct. 23, 2014

(54) POSITIVE ACTIVE MATERIAL, METHOD OF PREPARING THE SAME, AND RECHARGEABLE LITHIUM BATTERY INCLUDING THE SAME

(71) Applicant: SAMSUNG SDI CO., LTD., Yongin-si (KR)

(72) Inventors: Dong-Hwan YU, Yongin-si (KR); Young-Jin CHOI, Yongin-si (KR); Young-Soo JUNG, Yongin-si (KR); Ji-Yong LEE, Yongin-si (KR); Sung-Hoon KIM, Yongin-si (KR)

(73) Assignee: SAMSUNG SDI CO., LTD., Yongin-si (KR)

(21) Appl. No.: 14/059,569

(22) Filed: Oct. 22, 2013

(30) Foreign Application Priority Data
Apr. 23, 2013 (KR) 10-2013-0044946

(51) Int. Cl. H01M 4/36; H01M 4/04; H01M 10/0525; H01M 4/525; H01M 4/62; H01M 4/131; H01M 4/1391

(52) U.S. Cl. CPC H01M 4/366; H01M 4/131; H01M 4/0402; H01M 4/1391; H01M 4/525; H01M 4/625; H01M 10/0525; H01M 2004/021
USPC 429/223; 427/122

(57) ABSTRACT

A method of manufacturing a positive active material includes dry-coating a surface of a material represented by LiₐNiₓCo_{y}Mn_{z}O₂, where 0.90≦a≦1.11, 0.5≦x<1.0, 0<y≦0.5, and 0<z≦0.5, and x+y+z=1, with a carbon material.

### CROSS-REFERENCE TO RELATED APPLICATION

Korean Patent Application No. 10-2013-0044946, filed on Apr. 23, 2013, in the Korean Intellectual Property Office, and entitled: “Positive Active Material and Method of Preparing Same, and Rechargeable Lithium Battery Including Positive Active Material,” is incorporated by reference herein in its entirety.

### BACKGROUND

1. Field

Embodiments are directed to a positive active material, a method of preparing the same, and a rechargeable lithium battery including the same.

2. Description of the Related Art

Lithium rechargeable batteries have recently drawn attention as a power source for small portable electronic devices. The lithium rechargeable batteries use an organic electrolyte and thereby, have a discharge voltage, that is twice or more as high as that of a conventional battery using an alkali aqueous solution. Accordingly, lithium rechargeable batteries have a high energy density.

### SUMMARY

Embodiments are directed to a method of manufacturing a positive active material for a rechargeable lithium battery including dry-coating a surface of a material represented by the following Chemical Formula 1 with a carbon material:

LiₐNiₓCo_{y}Mn_{z}O₂ [Chemical Formula 1]
wherein,
0.90≦a≦1.11, 0.5≦x<1.0, 0<y≦0.5, and 0<z≦0.5, and x+y+z=1.

The dry-coating may be performed by introducing the material represented by Chemical Formula 1 and the carbon material into a multipurpose mixer or a mechanofusion mixer, and mixing the same.

The dry-coating may be performed for about 1 minute to about 30 minutes.

The dry-coating may be performed by mixing the carbon material in an amount of about 0.1 parts by weight to about 1.5 parts by weight with 100 parts by weight of the material represented by Chemical Formula 1.

The carbon material may include natural graphite, artificial graphite, carbon black, acetylene black, ketjen black, a carbon fiber, a carbon nanotube, a conductive polymer, or a combination thereof.

The carbon material may have a specific surface area of about 50 m²/g to about 2000 m²/g.

In Chemical Formula 1, x, y, and z may be within the following ranges: 0.6≦x<1.0, 0<y≦0.4 and 0<z≦0.4.

Embodiments are also directed to a positive active material for a rechargeable lithium battery that is according to the above-described method.

The positive active material may include the material represented by Chemical Formula 1, and a coating layer of the carbon material formed on a surface of the material represented by Chemical Formula 1.

The carbon material may be included in an amount of about 0.1 parts by weight to about 1 part by weight based on 100 parts by weight of the material represented by Chemical Formula 1.

The carbon material may be natural graphite, artificial graphite, carbon black, acetylene black, ketjen black, a carbon fiber, a carbon nanotube, a conductive polymer, or combination thereof.

The carbon material may have a specific surface area of about 50 m²/g to about 2,000 m²/g.

In Chemical Formula 1, x, y, and z may be within the following ranges: 0.6≦x<1.0, 0<y≦0.4 and 0<z≦0.4.

Embodiments are also directed to a rechargeable lithium battery including a positive electrode including the positive active material as described above, a negative electrode, and an electrolyte.

### BRIEF DESCRIPTION OF THE DRAWINGS

Features will become apparent to those of skill in the art by describing in detail exemplary embodiments with reference to the attached drawings in which:

FIG. 1 illustrates a schematic view showing a rechargeable lithium battery according to an embodiment.

FIG. 2 illustrates an electron microscope image showing the positive active material according to Example 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

According to an embodiment, a method of manufacturing a positive active material for a rechargeable lithium battery includes dry-coating a surface of a material represented by the following Chemical Formula 1 with a carbon material.

LiₐNiₓCo_{y}Mn_{z}O₂ [Chemical Formula 1]

In the above Chemical Formula 1, 0.90≦a≦1.11, 0.5≦x<1.0, 0<y≦0.5, and 0<z≦0.5, and x+y+z=1.

The term “dry-coating” refers to a coating method without using a solution. In addition, the term does not include ball milling dry-coating.

The dry-coating may be performed by introducing, for example, a material represented by the above Chemical Formula 1 and the carbon material into a multipurpose mixer or a mechanofusion mixer and then, mixing the same.

The material represented by the above Chemical Formula 1 is a lithium nickel composite oxide including a Ni-rich active material in which nickel is present in an amount of greater than or equal to about 50 mol %. For example, the nickel may be included in an amount of greater than or equal to about 50 mol %, greater than or equal to about 55 mol %, greater than or equal to about 60 mol %, greater than or equal to about 65 mol %, or greater than or equal to about 70 mol %. In the above Chemical Formula 1, as examples, 0.6≦x<1.0, 0<y≦0.4 and 0<z≦0.4, or 0.7≦x<1.0, 0<y≦0.3 and 0<z≦0.3, or 0.5≦x≦0.8, 0.1≦y≦0.5 and 0.1≦z≦0.5, or 0.6≦x≦0.8, 0.1≦y≦0.4, and 0.1≦z≦0.4.

This nickel-rich active material may realize a high-rate charge and discharge and high-rate output characteristics. In particular, the nickel-rich active material may have a higher energy density and a lower cost, as the amount of nickel increases.

When the lithium nickel composite oxide is coated with a carbon material on the surface, resistance between the active material and a current collector may decrease, and adherence therebetween may improve, and battery conductivity of the active material may increase. In addition, high power and cycle-life characteristics and stability of a battery may be improved.

However, if the active material were to be coated with a carbon material using a wet coating method of dispersing a carbon material in a solvent and introducing/mixing a lithium nickel composite oxide, a large amount of carbon material may be consumed during the manufacture process. In addition, a process of dispersing the carbon material in a solution may be required, and a process of drying at a high temperature after mixing the carbon material and lithium nickel composite oxide in a solution may be additionally required. Thereby, the manufacturing processes may be complicated and time-consuming.

In addition, a method of coating carbon nanotube using a drying ball milling method also requires a large amount of a carbon material, and the method may be time-consuming, so as to not be suitable for the mass production.

In particular, in case of a nickel rich active material including much nickel, when a large amount of carbon material is used in the coating, and the coating time is prolonged, Li₂Co₃, LiOH, and the like that may remain therein may have a side-reaction with an electrolyte, and a byproduct layer such as lithium carbonate and the like may be formed on the surface of the active material. In addition, gas may be generated during the reaction and battery resistance may be increased. Accordingly, battery characteristics such as cycle-life, high power, and high-rate characteristics, stability, and the like may deteriorate.

In contrast, a method of manufacturing a positive active material according to the present embodiment may provide a sufficient coating effect even though carbon in a very small amount is included in the nickel rich active material, and shorten the coating time may be shortened to be within 30 minutes. Accordingly, the positive active material may have a sufficient coating effect of a carbon material, while a byproduct layer may not be formed on the surface of the active material.

In addition, although a small amount of conductive material may be added to the positive electrode, r even if such conductive material is not added, the electrical conductivity may be sufficient, such that the energy density of positive active material may be enhanced.

As a result, high-capacity characteristics, high power characteristics, high-rate characteristics, and cycle-life characteristics of a battery may be remarkably improved.

As examples, in a method of manufacturing the positive active material according to the present embodiment, the carbon material may be used or mixed in an amount of about 0.1 parts by weight to about 1.5 parts by weight, or about 0.2 parts by weight to about 1.5 parts by weight, or about 0.3 parts by weight to about 1.5 parts by weight, or about 0.1 parts by weight to about 1 part by weight, or about 0.2 parts by weight to 1 part by weight, based on 100 parts by weight of the material represented by the above Chemical Formula 1.

These amounts of the carbon material are remarkably smaller than the amount of a carbon material used for a conventional coating method but may bring about a sufficient coating effect within the range and may prevent the formation of a byproduct layer on the surface of a nickel rich active material. Accordingly, the positive active material may not only be economical but also may provide improves battery characteristics such as high-capacity, high power, and the like.

The dry-coating may be performed for about 1 minute to about 30 minutes. For example, the dry-coating may be performed for about 1 minute to about 25 minutes, or about 1 minute to about 20 minutes. The dry-coating takes a remarkably shorter amount of time than the conventional coating. Accordingly, the dry-coating method may not only be simple and may shorten the coating time, but also may prevent formation of a byproduct layer on the surface of the nickel rich active material. Thus, battery characteristics such as high-capacity, high power, and the like may be improved.

The carbon material may be any suitable carbon material. For example natural graphite, artificial graphite, carbon black, acetylene black, ketjen black, a carbon fiber, a carbon nanotube, a conductive polymer, or a combination thereof. For example, carbon black, acetylene black, or ketjen black may be used.

The carbon material may have a specific surface area of about 50 m²/g to about 2,000 m²/g, or, for example, about 50 m²/g to about 1,000 m²/g, about 50 m²/g to about 900 m²/g, about 50 m²/g to about 500 m²/g, or about 50 m²/g to about 300 m²/g. When the carbon material has a specific surface area within the range, the positive active material may bring about excellent battery characteristics such as high-capacity, high power, and the like.

The dry-coating may form a continuous or discontinuous carbon material coating layer on the surface of a material represented by the above Chemical Formula 1. The coating layer does not include a byproduct such as lithium carbonate and the like.

In another embodiment, a positive active material for a rechargeable lithium battery includes a material represented by the following Chemical Formula 1 and a coating layer of the carbon material formed on a surface of the material represented by the above Chemical Formula 1.

LiₐNiₓCo_{y}Mn_{z}O₂ [Chemical Formula 1]

In the above Chemical Formula 1, 0.90≦a≦1.11, 0.5≦x<1.0, 0<y≦0.5, and 0<z≦0.5, and x+y+z=1.

The positive active material includes nickel in an amount of greater than or equal to about 50 mol % and thus, the positive active material may provide high-capacity and high power characteristics. Formation of a byproduct layer on the surface thereof may be prevented because a carbon material is used in a very small amount. Thus, high-capacity, high power, high-rate, and cycle-life characteristics of a battery may be remarkably improved.

As examples, the nickel may be included in an amount of greater than or equal to about 50 mol %, greater than or equal to about 55 mol %, greater than or equal to about 60 mol %, greater than or equal to about 65 mol %, or greater than or equal to about 70 mol %. As examples, in the above Chemical Formula 1, 0.6≦x<1.0, 0<y≦0.4 and 0<z≦0.4, 0.7≦x<1.0, 0<y≦0.3 and 0<z≦0.3, 0.5≦x≦0.8, 0.1≦y≦0.5 and 0.1≦z≦0.5, or 0.6≦x≦0.8, 0.1≦y≦0.4 and 0.1≦z≦0.4.

As examples, the carbon material may be included in an amount of about 0.1 parts by weight to about 1.5 parts by weight, about 0.2 parts by weight to about 1.5 parts by weight, about 0.3 parts by weight to about 1.5 parts by weight, about 0.1 parts by weight to about 1 part by weight, or about 0.2 parts by weight to about 1 part by weight based on 100 parts by weight of the material represented by the above Chemical Formula 1. The carbon material may be used in a remarkably smaller amount than a carbon material used for the conventional active material, but may nevertheless bring about a sufficient coating effect within the range. Formation of a byproduct layer on the surface of the nickel rich active material may be prevented, and accordingly, the positive active material may be economical and may have improved battery characteristics such as high-capacity, high power, and the like.

The carbon material may be any suitable material used in the art, for example, natural graphite, artificial graphite, carbon black, acetylene black, ketjen black, carbon fiber, carbon nanotube, conductive polymer, or a combination thereof. For example, carbon black, acetylene black, or ketjen black may be used.

As examples, the carbon material may have a specific surface area of about 50 m²/g to about 2,000 m²/g, about 50 m²/g to about 1,000 m²/g, about 50 m²/g to about 900 m²/g, about 50 m²/g to about 500 m²/g, or about 50 m²/g to about 300 m²/g. When the carbon material has a specific surface area within the range, the positive active material may realize excellent battery characteristics such as high-capacity, high power, and the like. The coating layer does not include a byproduct such as lithium carbonate and the like.

The positive active material may have a secondary particle structure formed by cohering primary particles. The primary particles may have an average particle diameter ranging from about 0.1 μm to about 3 μm. The secondary particle may have an average particle diameter ranging from about 3 μm to about 15 μm. In other implementations, the positive active material may have various particle diameter ranges. When the positive active material has a particle diameter within these ranges, excellent high power, high-capacity characteristics, and the like may be obtained.

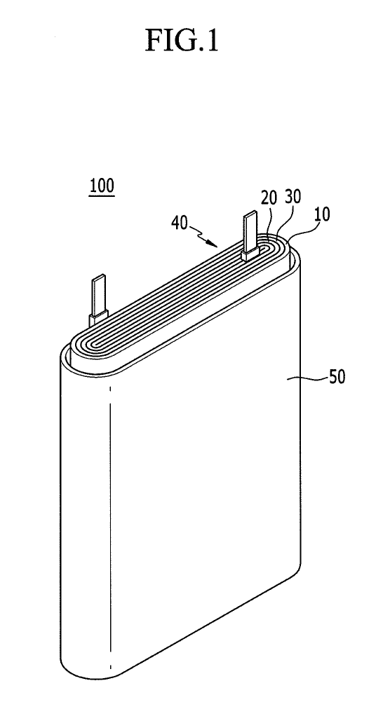

In another embodiment, a rechargeable lithium battery includes a positive electrode including the positive active material, a negative electrode, and an electrolyte. A rechargeable lithium battery according to the present embodiment is described referring to FIG. 1. FIG. 1 is a schematic view showing a rechargeable lithium battery according to the present embodiment.

Referring to FIG. 1, a rechargeable lithium battery 100 according to the present embodiment includes an electrode assembly 40 manufactured by winding a positive electrode 10, a negative electrode 20, and a separator 30, which interposed between the positive electrode 10 and the negative electrode 20, and a case 50 housing the electrode assembly 40. An electrolyte (not shown) may be impregnated in the positive electrode 10, the negative electrode 20, and the separator 30.

The positive electrode 10 may include a current collector and a positive active material layer formed on the current collector. The positive active material layer includes a positive active material that is the same as that described above.

The current collector may be Al, as an example.

The positive active material layer may further include a binder. The binder may bind positive active material particles to each other and to a current collector.

Examples of the binder may include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

The positive active material layer may further include a small amount of conductive material. The conductive material may improve the electrical conductivity of the positive electrode. Any suitable electrically conductive material that does not cause a chemical change may be used. Examples of the conductive material include one or more of natural graphite, artificial graphite, carbon black, acetylene black, ketjen black, a carbon fiber, a metal powder or a metal fiber of copper, nickel, aluminum, silver, or the like, a polyphenylene derivative, or the like.

The positive active material according to embodiments includes a coating layer including a carbon material on the surface. Accordingly, sufficient electrical conductivity may be realized regardless of whether a conductive material is used or a conductive material is not used in the positive electrode.

The negative electrode 20 may include a current collector and a negative active material layer formed on the current collector. The negative active material layer may include a negative active material.

The negative active material may include a material that reversibly intercalates/deintercalates lithium ions, a lithium metal, a lithium metal alloy, a material being capable of doping and dedoping lithium, or a transition metal oxide.

The material that reversibly intercalates/deintercalates lithium ions may be a carbon material, and may be any carbon-based negative active material suitable for use in a rechargeable lithium ion battery. Examples thereof may include crystalline carbon, amorphous carbon, or a combination thereof. The crystalline carbon may be shapeless or sheet, flake, spherical, or fiber-shaped natural graphite or artificial graphite. The amorphous carbon may be a soft carbon, a hard carbon, a mesophase pitch carbonized product, fired coke, or the like.

The lithium metal alloy may include lithium and a metal of Na, K, Rb, Cs, Fr, Be, Mg, Ca, Sr, Si, Sb, Pb, In, Zn, Ba, Ra, Ge, Al, or Sn.

The material being capable of doping and dedoping lithium may include Si, SiOₓ (0<x<2), a Si—C composite, a Si-Q alloy (wherein Q is an alkali metal, an alkaline-earth metal, a Group 13 to 16 element, a transition metal, a rare earth element, or a combination thereof, and is not Si), Sn, SnO₂, a Sn—C composite, a Sn—R alloy (wherein R is an alkali metal, an alkaline-earth metal, a Group 13 to 16 element, a transition metal, a rare earth element, or a combination thereof, and is not Sn), or the like. Specific selections of Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include vanadium oxide, lithium vanadium oxide, and the like.

The negative active material layer includes a binder, and may optionally include a conductive material.

The binder may bind negative active material particles to each other and to a current collector. Examples of the binder may include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material improves the electrical conductivity of the negative electrode. Any suitable electrically conductive material that does not cause a chemical change may be used. Examples of the conductive material include a carbon-based material such as natural graphite, artificial graphite, carbon black, acetylene black, ketjen black, a carbon fiber, or the like; a metal-based material such as a metal powder or a metal fiber of copper, nickel, aluminum, silver, or the like; a conductive polymer such as a polyphenylene derivative; or a mixture thereof.

The current collector may be a copper foil, a nickel foil, a stainless steel foil, a titanium foil, a nickel foam, a copper foam, a polymer substrate coated with a conductive metal, or a combination thereof.

The electrolyte may include a non-aqueous organic solvent and a lithium salt.

The non-aqueous organic solvent may play a role of transferring ions taking part in the electrochemical reaction of a battery.

The non-aqueous organic solvent may include a carbonate-based, ester-based, ether-based, ketone-based, alcohol-based, or aprotic solvent. The carbonate based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester based solvent may include methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, or the like. The ether-based solvent may be, for example, dibutylether, tetraglyme, diglyme, dimethoxyethane, 2-methyltetrahydrofuran, tetrahydrofuran, or the like. The ketone based solvent may be cyclohexanone, or the like. The alcohol-based solvent may be ethanol, isopropyl alcohol, or the like. The aprotic solvent may include a nitrile such as R—CN (wherein R is a C2 to C20 linear, branched, or cyclic hydrocarbon group, and may include one or more double bonds, one or more aromatic rings, or one or more ether bonds), an amide such as dimethylformamide or dimethylacetamide, a dioxolane such as 1,3-dioxolane, a sulfolane, or the like.

The non-aqueous organic solvent may be used singularly or in a mixture. When the organic solvent is used in a mixture, the mixture ratio may be controlled in accordance with a desirable performance of the battery.

The carbonate-based solvent may include a mixture of a cyclic carbonate and a linear carbonate. When the cyclic carbonate and the linear carbonate are mixed together in a volume ratio of about 1:1 to about 1:9 in the electrolyte, the electrolyte may have an enhanced performance.

The non-aqueous organic solvent may further include an aromatic hydrocarbon-based solvent as well as the carbonate-based solvent. The carbonate-based solvent and the aromatic hydrocarbon-based solvent may be mixed together in a volume ratio of about 1:1 to about 30:1.

The non-aqueous electrolyte may further include vinylene carbonate or an ethylene carbonate-based compound in order to improve the cycle-life of the battery.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, vinylene ethylene carbonate, or the like. When the vinylene carbonate or the ethylene carbonate-based compound is further used, the amounts thereof may be appropriately adjusted for improving cycle-life.

The lithium salt is dissolved in the non-aqueous organic solvent. The lithium salt supplies a battery with lithium ions, basically operates the rechargeable lithium battery, and improves transportation of the lithium ions between positive and negative electrodes. Examples of the lithium salt include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, LiB(C₂O₄)₂ (lithium bis(oxalato) borate; LiBOB), or a combination thereof, which is used as a supporting electrolytic salt. The lithium salt may be used in a concentration ranging from about 0.1 M to about 2.0 M. When the lithium salt is included at the above concentration range, an electrolyte may have optimal electrolyte conductivity and viscosity, and may thus have enhanced performance and effective lithium ion mobility.

The separator 30 may include any suitable material to separate a negative electrode from a positive electrode and provide a transporting passage for lithium ions. The separator may be made of a material having a low resistance to ion transportation and an improved impregnation for an electrolyte. For example, the material may be selected from a glass fiber, polyester, TEFLON (tetrafluoroethylene), polyethylene, polypropylene, polytetrafluoroethylene (PTFE), or a combination thereof. The separator 30 may have a form of a non-woven fabric or a woven fabric. For example, a polyolefin-based polymer separator such as polyethylene, polypropylene or the like may be used for a lithium ion battery. In order to ensure the heat resistance or mechanical strength, a coated separator including a ceramic component or a polymer material may be used. As examples, the separator may have a mono-layered or multi-layered structure.

The following Examples and Comparative Examples are provided in order to highlight characteristics of one or more embodiments. It is to be understood that the Examples and Comparative Examples are not to be construed as limiting the scope of the embodiments, nor are the Comparative Examples to be construed as being outside the scope of the embodiments. Further, it is to be understood that the embodiments are not limited to the particular details described in the Examples and Comparative Examples.

### Example 1

### Manufacture of Positive Active Material

100 parts by weight of LiNi_{0.6}CO_{0.2}Mn_{0.2}O₂, and 0.2 parts by weight of carbon black having a specific surface area of about 100 m²/g as a carbon material were introduced into a multipurpose mixer and mixed for 10 minutes to 15 minutes.

Manufacture of Rechargeable Lithium Battery Cell

(Positive Electrode)

95 wt % of the obtained positive active material and 5 wt % of polyvinylidene fluoride (PVdF) binder were mixed and added with an N-methylpyrrolidone (NMP) solvent to provide a positive active material slurry. The obtained positive active material slurry was coated onto an aluminum foil and dried, followed by roll-pressing, to provide a positive electrode.

(Negative Electrode)

95 wt % of natural graphite as a negative active material and 5 wt % of polyvinylidene fluoride as a binder were mixed to provide a negative active material slurry. The obtained negative active material slurry was coated onto a copper foil and dried, followed by roll pressing, to provide a negative electrode.

(Battery Cell Assembly)

The obtained positive electrode and negative electrode, and a polyethylene separator were used and were injected with an electrolyte (1 mole of lithium hexafluorophosphate (LiPF₆), ethylene carbonate (EC)/ethylmethylcarbonate (EMC)=1/2 volume ratio) to provide a prismatic cell.

### Example 2

A positive active material and a rechargeable lithium battery cell were manufactured in accordance with the same procedure as in Example 1, except that 0.5 parts by weight of carbon black was used.

### Example 3

A positive active material and a rechargeable lithium battery cell were manufactured in accordance with the same procedure as in Example 1, except that 1.0 part by weight of carbon black was used.

### Comparative Example 1

A rechargeable lithium battery cell was manufactured in accordance with the same procedure as in Example 1, except that a positive active material that was not coated with carbon black was used.

### Evaluation Example 1

### Scanning Electron Microscope (FE-SEM) and Transmission Electron Microscope (TEM) Evaluation

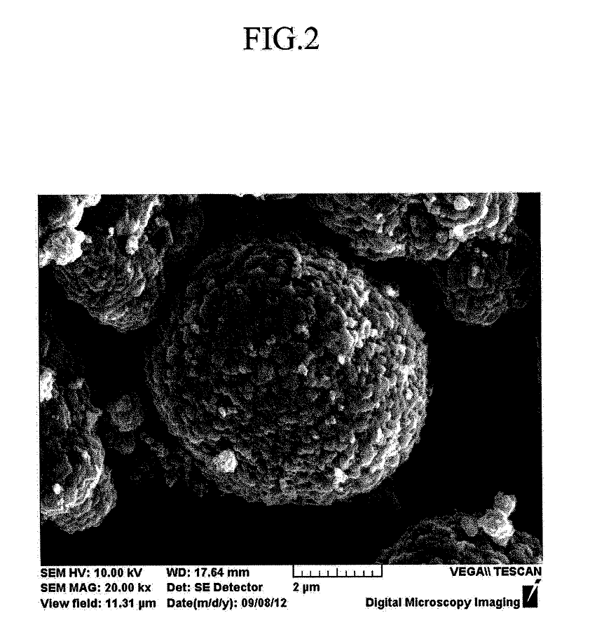

The scanning electron microscope image of the positive active material according to Example 2 is illustrated in FIG. 2. Referring to FIG. 2, it may be confirmed that the carbon black was uniformly coated on the surface of the active material.

### Evaluation Example 2

### Battery Cell Evaluation

The specific resistance and charge and discharge characteristics of the rechargeable lithium battery cells according to Examples 1 to 3 and Comparative Example 1 were measured, and the results are shown in the following Table 1.

The charge and discharge cut-off voltage was set in 4.2-3.0 V, and the charge and discharge was determined by measuring the efficiency relative to the initial capacity (0.2 C) after performing under the constant current mode at 10 C, and 20 C, respectively.

TABLE 1

| | Coating | Specific | | |
|---|---|---|---|---|
| | amount | resistance of | Capacity | Capacity |
| | of carbon black | electrode | Efficiency | Efficiency |
| | (wt %) | (Ω · m) | (10 C/0.2 C) | (20 C/0.2 C) |
| Comparative | 0 | 5.7 | 82% | 70% |
| Example 1 | | | | |
| Example 1 | 0.2 | 5.1 | 84% | 77% |
| Example 2 | 0.5 | 4.1 | 87% | 83% |
| Example 3 | 1.0 | 3.8 | 92% | 86% |

Referring to Table 1, it can be seen that the specific resistance of electrode according to Examples was decreased compared to Comparative Examples, and the capacity efficiency was significantly improved at 10 C and 20 C.

By way of summation and review, rechargeable lithium batteries include an electrolyte, and a positive electrode including a positive active material that can intercalate and deintercalate lithium and a negative electrode including a negative active material that can intercalate and deintercalate lithium.

As for a positive active material for a lithium rechargeable battery, a lithium-transition metal oxides being capable of intercalating lithium, such as LiCoO₂, LiMn₂O₄, LiNi₁₋ₓCoₓO₂ (0<x<1), and the like, has been researched.

As for the negative active material for the lithium rechargeable battery, various carbon-based materials such as artificial graphite, natural graphite, and hard carbon capable of intercalating and deintercalating lithium ions have been used. Recently, a negative active material such as tin oxide, silicon oxide, vanadium oxide, and the like has been developed.

Recently, demands for high power, high-capacity batteries have remarkably increased, and thus, the development of batteries having improved high power, high-capacity, high-rate, and high cycle-life characteristics is desirable.

Embodiments provide a positive active material having low resistance with respect to a current collector, a high energy density, and improved high-capacity characteristics, high power characteristics, high-rate characteristics, and cycle-life characteristics. Embodiments also provide a method of manufacturing the positive active material. Embodiments also provide a rechargeable lithium battery including the positive active material has improved high-capacity characteristics, high power characteristics, high-rate characteristics, and cycle-life characteristics.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope thereof as set forth in the following claims.

What is claimed is:

1. A method of manufacturing a positive active material for a rechargeable lithium battery, the method comprising dry-coating a surface of a material represented by the following Chemical Formula 1 with a carbon material:
LiₐNiₓCo_{y}Mn_{z}O₂ [Chemical Formula 1]
wherein,
0.90≦a≦1.11, 0.5≦x<1.0, 0<y≦0.5, and 0<z≦0.5, and x+y+z=1.

2. The method as claimed in claim 1, wherein the dry-coating is performed by introducing the material represented by Chemical Formula 1 and the carbon material into a multipurpose mixer or a mechanofusion mixer, and mixing the same.

3. The method as claimed in claim 1, wherein the dry-coating is performed for about 1 minute to about 30 minutes.

4. The method as claimed in claim 1, wherein the dry-coating is performed by mixing the carbon material in an amount of about 0.1 parts by weight to about 1.5 parts by weight with 100 parts by weight of the material represented by Chemical Formula 1.

5. The method as claimed in claim 1, wherein the carbon material includes natural graphite, artificial graphite, carbon black, acetylene black, ketjen black, a carbon fiber, a carbon nanotube, a conductive polymer, or a combination thereof.

6. The method as claimed in claim 1, wherein the carbon material has a specific surface area of about 50 m²/g to about 2,000 m²/g.

7. The method as claimed in claim 1, wherein, in Chemical Formula 1, x, y, and z are within the following ranges: 0.6≦x<1.0, 0<y≦0.4 and 0<z≦0.4.

8. A positive active material for a rechargeable lithium battery prepared according to the method as claimed in claim 1.

9. The positive active material as claimed in claim 8, wherein the positive active material includes:
the material represented by Chemical Formula 1, and
a coating layer of the carbon material formed on a surface of the material represented by Chemical Formula 1.

10. The positive active material as claimed in claim 8, wherein positive active material includes the carbon material in an amount of about 0.1 parts by weight to about 1 part by weight based on 100 parts by weight of the material represented by Chemical Formula 1.

11. The positive active material as claimed in claim 8, wherein the carbon material is natural graphite, artificial graphite, carbon black, acetylene black, ketjen black, a carbon fiber, a carbon nanotube, a conductive polymer, or combination thereof.

12. The positive active material as claimed in claim 8, wherein the carbon material has a specific surface area of about 50 m²/g to about 2,000 m²/g.

13. The positive active material as claimed in claim 8, wherein in Chemical Formula 1, x, y, and z are within the following ranges: 0.6≦x<1.0, 0<y≦0.4 and 0<z≦0.4.

14. A rechargeable lithium battery, comprising:
a positive electrode including the positive active material as claimed in claim 8,
a negative electrode, and
an electrolyte.
